(19) United States
(12) Patent Application Publication
(10) Pub. No.: US 2008/0010282 A1
(43) Pub. Date: Jan. 10, 2008

(54) File metadata lease management

(75) Inventors: John R. Douceur, Bellevue, WA (US); Jonathan R. Howell, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/482,629

(22) Filed: Jul. 7, 2006

(51) Int. Cl. G06F 17/30

(52) U.S. Cl. 707/8

(57) ABSTRACT

Each file in a file system has one or more associated metadata fields, and each metadata field is associated with a different lease. A computing device sends a request to a directory server for one or more leases that are needed by the computing device to perform an operation on a file. The directory server receives the request from the computing device and determines whether the operation can succeed. One or more leases to perform the operation are issued to the computing device if it is determined that the operation can succeed, and one or more leases that reveal failure are issued to the computing device if it is determined that the operation cannot succeed. The computing device receives the issued lease(s) and uses the received lease(s) to determine whether the computing device can perform the operation on the file.

### BACKGROUND

File systems manage files in computer systems. The file system maintains metadata describing each file in the computer system, and for certain files this meta data includes an identifier of the physical location of data corresponding to the file. File systems were originally built into a computer's operating system to facilitate access to files stored locally on resident storage media. As computers became networked, some file storage capabilities were offloaded from individual user machines to special storage servers that stored large numbers of files on behalf of the user machines. In this server-based architecture, the file system was extended to facilitate management of and access to files stored remotely at the storage server over a network. Today, file storage is migrating toward a model in which files are stored on various networked computers, rather than on a central storage server.

However, one problem that is encountered in file systems spanning a computer network is the ability for multiple computers to request access to the same file concurrently. These can lead to conflicts between the computers and can lead to data inconsistencies if not handled properly. For example, if two computers were to request and receive access to the same file at the same time, and each of the computers were to write a different value into the file, then the system enters an inconsistent state because it is unclear what value the file should have. Thus, it would be beneficial to have a way to maintain consistency in file systems, and to do so in an efficient manner to improve the performance of the file system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

File metadata lease management manages leases over file metadata in a file system. Each file in the file system has one or more associated metadata fields, and each metadata field is associated with a different lease.

In accordance with certain embodiments, a computing device sends a request to a directory server for one or more leases that are needed by the computing device to perform an operation on a file. The computing device receives the lease(s) from the directory server and uses the received lease(s) to determine whether the computing device can perform the operation on the file.

In accordance with certain embodiments, the directory server receives a request from a computing device for one or more leases that are needed by the computing device to perform an operation on a file, and determines whether the operation can succeed. One or more leases to perform the operation are issued to the computing device if it is determined that the operation can succeed, and one or more leases that reveal failure are issued to the computing device if it is determined that the operation cannot succeed.

### BRIEF DESCRIPTION OF THE DRAWINGS

The same numbers are used throughout the drawings to reference like features.

FIG. 1 illustrates an example system in which the file metadata lease management described herein can be employed.

FIG. 2 illustrates an example network environment that supports a serverless distributed file system.

FIG. 3 illustrates an example of file metadata.

FIG. 4 illustrates an example process for responding to requests for leases.

FIG. 5 illustrates an example process for handling lease requests in a request queue.

FIG. 6 illustrates an example process for issuing one or more leases to the requesting device for the requesting device to successfully perform the operation.

FIG. 7 illustrates an example process for handling lease requests in a request queue for delete operations.

FIG. 8 illustrates an example process for requesting leases.

FIG. 9 illustrates an example process for computing devices suppressing lease requests.

FIG. 10 illustrates an example process for directory servers suppressing lease requests.

FIG. 11 is an example message flow diagram.

FIG. 12 is a state diagram illustrating example states of a system employing the exclusive enable policy.

FIG. 13 is another example message flow diagram.

FIG. 14 illustrates an example process for directory servers processing lease release messages.

FIG. 15 illustrates logical components of an example computing device.

FIG. 16 illustrates an example of a general computing device that can be used to implement the file metadata lease management discussed herein.

### DETAILED DESCRIPTION

File metadata lease management is described herein. The metadata for each file is subdivided into multiple fields, and each of these fields has a separate associated lease. Each lease, when issued to a computer, allows the computer to access the associated field. Different computers can be issued leases for different fields of the metadata of the same file concurrently.

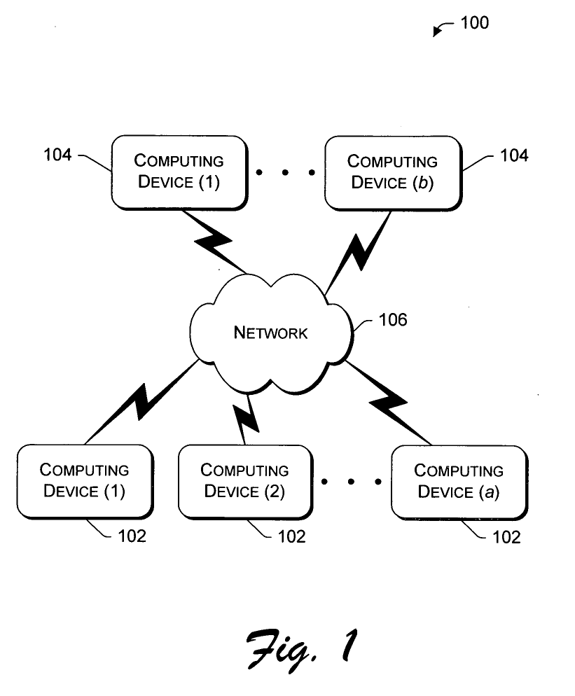

FIG. 1 illustrates an example system 100 in which the file metadata lease management described herein can be employed. System 100 includes multiple (a) computing devices 102 that can communicate with multiple (b) computing devices 104, as well as other computing devices 102, via a data communications network 106. Although multiple computing devices 102 and 104 are shown, alternatively system 100 may include only a single computing device 102 and/or a single computing device 104.

Computing devices 102 and 104 represent any of a wide range of computing devices, and each device may be the same or different. By way of example, devices 102 and 104 may be desktop computers, laptop computers, handheld or pocket computers, personal digital assistants (PDAs), cellular phones, Internet appliances, consumer electronics devices, gaming consoles, and so forth.

Network 106 represents any of a wide variety of data communications networks. Network 106 may include public portions (e.g., the Internet) as well as private portions (e.g., an internal corporate Local Area Network (LAN)), as well as combinations of public and private portions. Network 106 may be implemented using any one or more of a wide variety of conventional communications media including both wired and wireless media. Any of a wide variety of communications protocols can be used to communicate data via network 106, including both public and proprietary protocols. Examples of such protocols include TCP/IP, IPX/SPX, NetBEUI, etc.

The computing devices 104 together operate to provide directory server functionality to the computing devices in system 100. Each computing device 104 can be a directory server, or alternatively multiple computing devices 104 may operate together to form a single virtual directory server. The directory servers are responsible for maintaining (also referred to as managing) files stored in system 100. This maintenance or management includes, for example, recording the metadata for the files, recording the physical location where data for files is stored, responding to requests for file identifiers, responding to requests for file metadata, responding to requests for a lease(s) to perform an operation on a file, and so forth.

System 100 can employ a traditional client-server file system, in which the computing devices 104 are dedicated file server devices that are accessed by computing devices 102. Alternatively, system 100 can employ a serverless distributed file system, as discussed in more detail below.

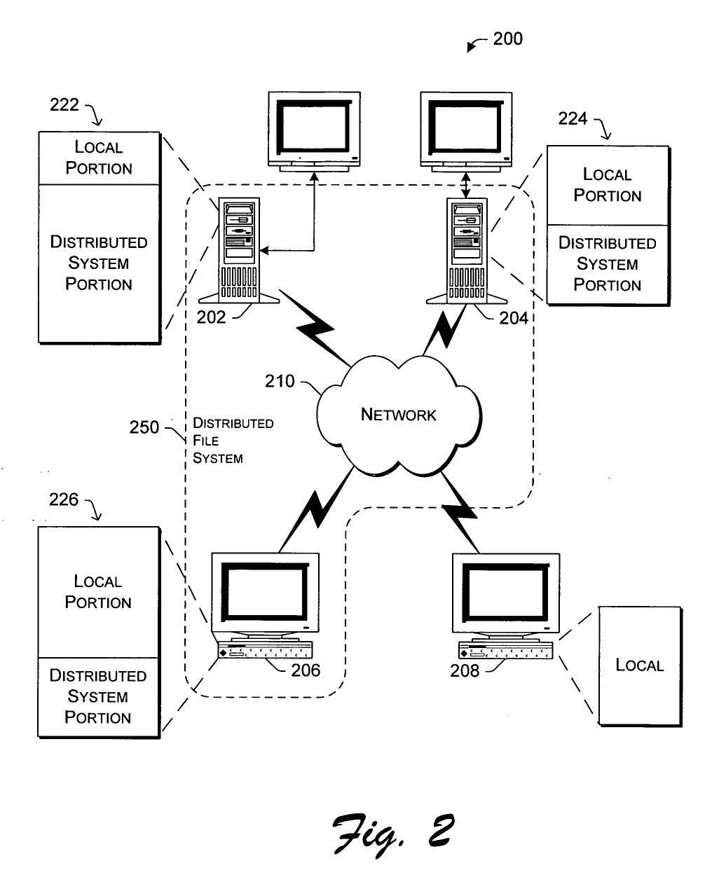

FIG. 2 illustrates an example network environment 200 that supports a serverless distributed file system. System 200 is an example implementation of system 100 of FIG. 1. Four computing devices 202, 204, 206, and 208 are coupled together via a data communications network 210. Analogous to the discussion above regarding network 106 of FIG. 1, data communications network 210 can be any of a wide variety of data communications networks. Although four computing devices are illustrated, different numbers (either greater or fewer than four) may be included in network environment 200.

Computing devices 202-208 represent any of a wide range of computing devices, and each device may be the same or different. By way of example, devices 202-208 may be desktop computers, laptop computers, handheld or pocket computers, personal digital assistants (PDAs), cellular phones, Internet appliances, consumer electronics devices, gaming consoles, and so forth.

Two or more of devices 202-208 operate to implement a serverless distributed file system. The actual devices participating in the serverless distributed file system can change over time, allowing new devices to be added to the system and other devices to be removed from the system. Each device 202-206 that implements (participates in) the distributed file system 250 has portions of its mass storage device(s) (e.g., hard disk drive) 222-226 allocated for use as either local storage or distributed storage. The local storage is used for data that the user desires to store on his or her local machine and not in the distributed file system structure. The distributed storage portion is used for data that the user of the device (or another device) desires to store within the distributed file system structure.

A distributed file system 250 operates to store one or more copies of files on different computing devices 202-206. When a new file is created by the user of a computer, he or she has the option of storing the file on the local portion of his or her computing device, or alternatively in the distributed file system. If the file is stored in the distributed file system 250, the file will be stored in the distributed system portion of the mass storage device(s) of one or more of devices 202-206. The user creating the file may not have the ability to control which device 202-206 the file is stored on, nor any knowledge of which device 202-206 the file is stored on. Additionally, replicated copies of the file will typically be saved, allowing the user to subsequently retrieve the file even if one of the computing devices 202-206 on which the file is saved is unavailable (e.g., is powered-down, is malfunctioning, etc.).

The distributed file system 250 is implemented by one or more components on each of the devices 202-206, thereby obviating the need for any centralized server to coordinate the file system. These components operate to determine where particular files are stored, how many copies of the files are created for storage on different devices, and so forth. Exactly which device will store which files depends on numerous factors, including the number of devices in the distributed file system, the storage space allocated to the file system from each of the devices, how many copies of the file are to be saved, and so on. Thus, the distributed file system allows the user to create and access files (as well as folders or directories) without any knowledge of exactly which other computing device(s) the file is being stored on.

The distributed file system 250 is designed to prevent unauthorized users from reading data stored on one of the devices 202-206. Thus, a file created by device 202 and stored on device 204 is not readable by the user of device 204 (unless he or she is authorized to do so). In order to implement such security, the contents of files as well as all file and directory names in directory entries are encrypted, and only authorized users are given the decryption key. Thus, although device 204 may store a file created by device 202, if the user of device 204 is not an authorized user of the file, the user of device 204 cannot decrypt (and thus cannot read) either the contents of the file or the file name in its directory entry.

Every computing device 202-206 in distributed file system 250 can have one or more of the following functions: it can be a client for a local user, it can be a repository for encrypted copies of files stored in the system, and it can be a member of a group of computers that maintain one or more directories. The computing device(s) that operate to maintain the one or more directories can be thought of as directory servers, although it is to be appreciated that system 200 is a serverless system and that such computing device(s) are not part of a traditional client-server pair with a centralized server serving multiple clients. A computing device 202-206 operating as a directory server can also have one or more components that are not operating as a directory server.

Each file (including folders and directories) stored in a system, such as system 100 of FIG. 1 or system 200 of FIG. 2, has associated metadata. The associated metadata describes various aspects of the file, such as information describing data that is associated with the file, information describing which devices may be currently using the file, information describing the parent and/or children of the file in the file system namespace tree, and so forth. The metadata is subdivided into multiple fields, and a different lease is associated with each of these fields.

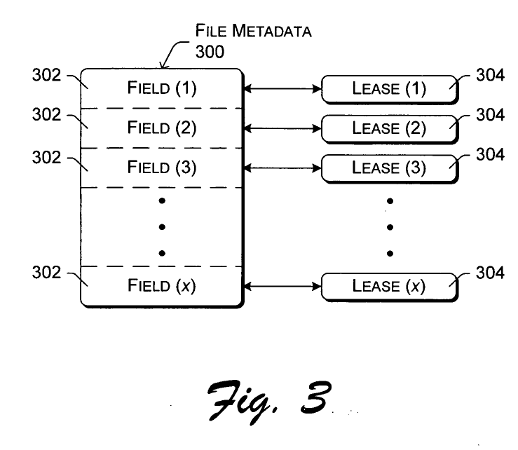

FIG. 3 illustrates an example of file metadata. File metadata 300 for a particular file is subdivided into multiple (x) fields 302. Each of these fields has an associated lease 304. The leases 304 are separate from one another, so the leases for different fields of the metadata associated with the same file are different. The leases 304 can be issued individually and do not all have to be issued concurrently. As the leases are per field rather than per file (or per group of files), the leases are referred to as being fine-grained.

The directory server receives requests from computing devices in the system and distributes the appropriate leases to those computing devices based on the requests. Rather than distributing a single lease covering an entire file or multiple files, the directory server distributes selected ones of the leases associated with the fields of the metadata of the files. Thus, two different computing devices can have leases over different fields of the same file concurrently. This is desirable, because outstanding leases allow clients to make progress without the delay and overhead associated with contacting the directory server. Conflicting leases obviate this benefit by requiring interaction with the directory server. The fine-grained leases described herein reduce the occasion of lease conflicts, providing more opportunities for leases to remain outstanding without directory server interaction.

When a lease is issued to a particular computing device, the lease indicates one or more operations that the computing device can perform on the associated field of the metadata. In certain embodiments, the operations that can be performed on a field include read operations and write operations. Read operations involve reading the data of the field—a lease allowing read operations allows the computing device to read the data of the field, but do not allow the computing device to write to or modify the data of the field. Write operations involve writing data to the field—a lease allowing write operations allows the computing device to read the data field and to write to the data field.

Depending on the rights at issue, multiple leases associated with the same field of the metadata can be issued to different computing devices concurrently. For example, multiple computing devices may concurrently hold leases that grant each of those multiple computing devices the right to read the data in the associated field. Typically, multiple computing devices are able to concurrently hold leases granting the devices the right to read data in a particular field, but only one computing device at a time can hold a lease granting the device the right to write data to a particular field. Furthermore, typically if any computing device holds a write lease over a particular field, no other computing device can hold a read lease over the same field.

The file metadata lease management techniques discussed herein can be used with any of a variety of different types of leases. For example, the leases may be conventional read leases and write leases as discussed above. By way of another example, the leases may be “black-box” leases. A black-box lease presents to each device an aggregation of other devices' values. For each data field protected by a black-box lease, each device has two sub-fields: SelfValue and OtherValue. The SelfValue field holds the device-specific value for the particular device, and the OtherValue field holds the aggregation of all other devices' SelfValues. The devices do not need to know what the aggregation function is; they only need to know what rules they should follow when using the OtherValues that they observe. Each device's SelfValue is protected by a SelfWrite lease. The device is allowed to change its SelfValue if and only if it holds the associated SelfWrite lease. Each device's OtherValue is protected by an OtherRead lease. The device is able to observe the state of its OtherValue if and only if it holds the associated OtherRead lease.

Each computing device maintains a record of which leases it has been issued by the directory server. The computing device also maintains a record of the state of various leases, indicating whether the lease has been issued or has not been issued to the computing device. In certain embodiments, by simply maintaining a record of which leases it has been issued, the computing device inherently maintains a record of which leases it has not been issued (that is, any lease that is not in its record of issued leases would be a not-issued lease).

Similarly, the directory server maintains a record of the state of each lease of each file that it manages. If a lease is issued to a computing device(s), the directory server maintains a record of which computing device(s) the lease was issued to.

The metadata can be subdivided into different fields in any of a variety of different manners. Typically, the subdivision will depend at least in part on the operating system being used and the particular metadata that is used by that operating system. In certain embodiments, where the operating system is one of the family of Microsoft Windows® operating systems, the metadata is subdivided into the following fields: a content field, a delete-pending field, a parent field, a child field, a handle open field, and a handle open for a particular mode field.

The content field stores data that identifies the content of a file, typically including the file length and a checksum of the contents of the file. The delete-pending field is a flag field that stores data indicating whether the file is delete-pending. A file that is delete-pending is to be deleted, and the last device to have a handle open on the file deletes the file. The parent field stores data that identifies the parent of the file in the file system namespace tree.

The child fields store data that identifies the child or children (if any) of the file in the file system namespace tree. The child fields are typically indexed by name, so that one client computing device may hold a lease on one child name of a given file, while a separate device simultaneously holds a lease on another child name of the same file. The handle open field stores data that indicates which device(s) have a handle: open on the file. The handle open for a particular mode fields store data that indicates which device(s) have a handle open on the file for a particular mode. The particular modes can include, for example, a reading mode (which allows the file to be read but not written to), and a writing mode (which allows the file to be written to).

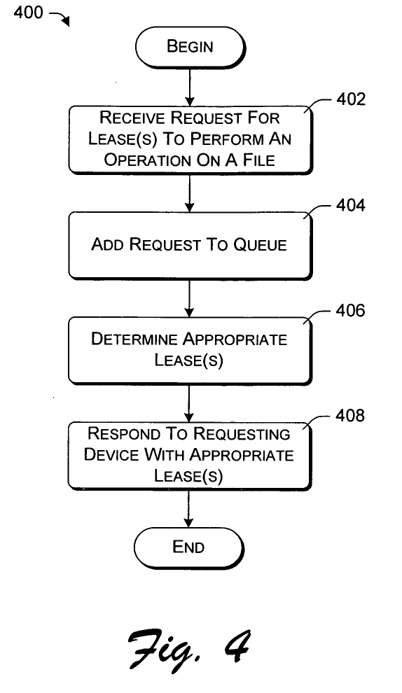

FIGS. 4-10 are flowcharts illustrating example processes for implementing the file metadata lease management described herein. FIG. 4 illustrates an example process 400 for responding to requests for leases. Process 400 can be carried out, for example, by a directory server (e.g., computing device 104 of FIG. 1), and may be implemented in software, firmware, hardware, or combinations thereof.

The directory server receives a request from a computing device (e.g., a computing device 102 of FIG. 1) for one or more leases for the computing device to perform an operation on a file (act 402). Typically, the computing device does not explicitly identify which lease(s) are desired. Rather, the desired operation is identified and the directory server is responsible for identifying which lease(s) are needed to perform the desired operation. This approach is desirable because often the directory server has access to more information, and is therefore in a better position to judge which leases will be necessary to satisfy (by failing or succeeding) the requested operation. For each operation that a computing device may possibly request a lease(s) for, the directory server is programmed with or otherwise is readily able to identify which lease(s) the computing device will need in order to perform the operation.

The directory server then adds the received request to a request queue (act 404). The directory server processes requests in the request queue, determining the appropriate lease(s) for the requests (act 406) and responding to the requesting device(s) with the appropriate lease(s) for the requests (act 408). If multiple leases are needed by the requesting device to perform the desired operation, these multiple leases may be gathered by the directory server and issued to the requesting device together after all are gathered, or alternatively the leases may be issued as they are gathered by the directory server. Issuing a lease to a device refers to the directory server maintaining an indication that the lease has been issued or granted to the device, and further communicating to the device an indication that it has been issued or granted the lease (e.g., sending a lease issue message to the device).

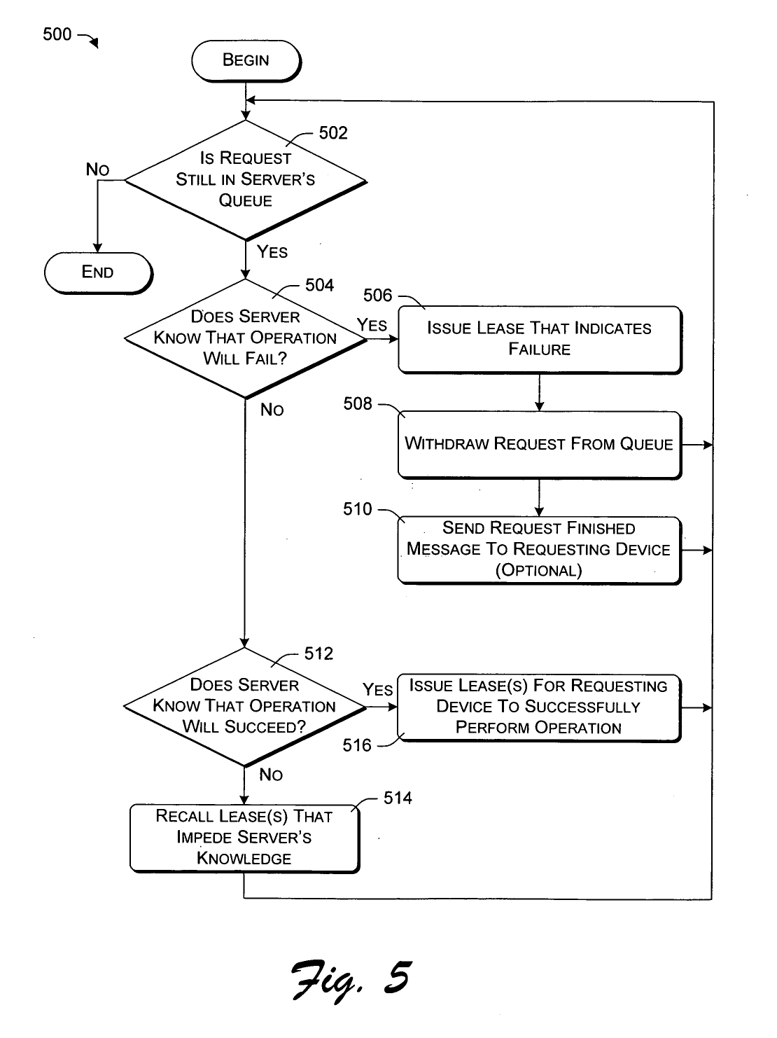

FIG. 5 illustrates an example process 500 for handling lease requests in a request queue. Process 500 can be carried out, for example, by a directory server (e.g., computing device 104 of FIG. 1), and may be implemented in software, firmware, hardware, or combinations thereof.

Initially, the directory server checks whether the request is still in the request queue (act 502). If the request is no longer in the request queue, then process 500 ends for that request. Process 500 is repeated for the request until the request is no longer in the request queue.

If the request remains in the request queue, then the directory server determines whether it knows that the operation will fail (act 504). The directory server may know that the operation will fail for a variety of different reasons, depending at least in part on the received request and any lease(s) that have already been issued by the directory server. For example, if the request is for lease(s) to open a file that does not exist, then the directory server knows that the operation will fail. By way of another example, if the request is for lease(s) to delete a file that has a child, then the directory server knows that the operation will fail.

If the directory server knows that the operation will fail, then the directory server issues a lease(s) from which the requesting device can determine for itself that the operation will fail (act 506). For example, a lease indicating that the requesting device does not have permission to access the file, or a lease indicating that some other computing device has exclusive access to the file. By way of another example, if the request is a request to open a file “foo.text”, then the server device may return a lease over the field that would store the file identifier for “foo.text” if it existed, but that instead stores a null value because “foo.text” does not exist. Alternatively, rather than issuing a lease(s) from which the requesting device can determine for itself that the operation will fail, the directory server may send a message to the requesting device that explicitly states that the operation will fail.

The directory server also withdraws the request from the request queue (act 508), and returns to the beginning of process 500 to repeat process 500. Optionally, the directory server can send a request finished message to the requesting computing device (act 510). The request finished message indicates to the client device that processing of the request by the directory server has been completed. This indication can be used by the client device to remove a request from its suppression set, as discussed in more detail below.

Returning to act 504, if the directory server does not know that the operation will fail, then the directory server determines whether it knows that the operation will succeed (act 512). If the directory server does not know that the operation will succeed, then the directory server recalls the lease(s) that impedes its knowledge (act 514), and returns to the beginning of process 500 to repeat process 500. For example, the request may be a request to open a file having a particular name, but another computing device may have a write lease over that file name. Since this other computing device may unlink the file from that file name, the directory server does not know whether the operation will succeed. Therefore, the server device sends a recall message to the other computing device to recall that write lease from the other computing device in act 514 so that it can know whether the operation will fail or succeed.

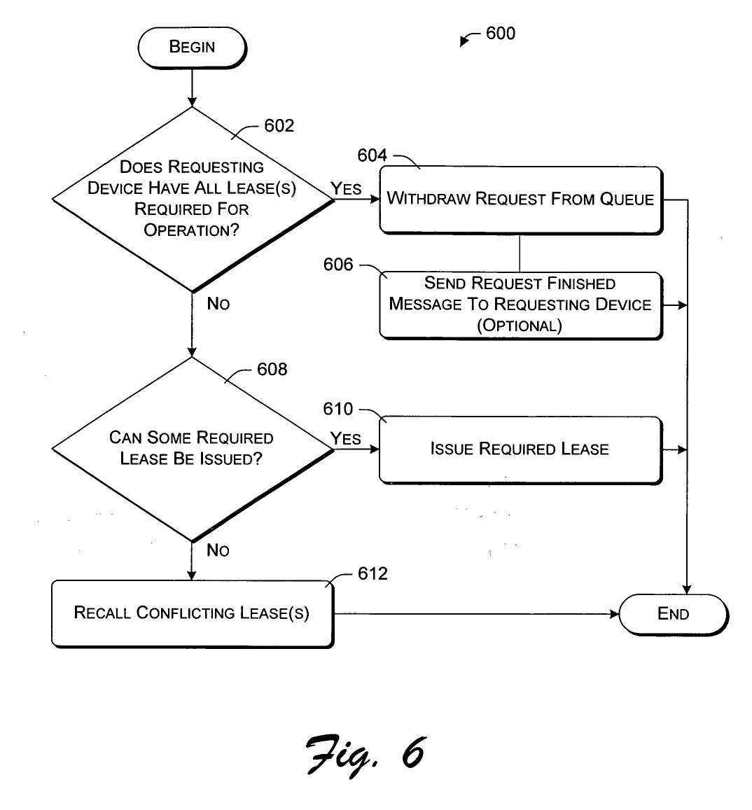

However, if the directory server knows that the operation will succeed, then the directory server issues one or more leases to the requesting device for the requesting device to successfully perform the operation (act 516). An example of act 516 is discussed in more detail below with reference to FIG. 6. The directory server then returns to the beginning of process 500 to repeat process 500.

FIG. 6 illustrates an example process 600 for issuing one or more leases to the requesting device for the requesting device to successfully perform the operation. Process 600 can be carried out, for example, by a directory server (e.g., computing device 104 of FIG. 1), and may be implemented in software, firmware, hardware, or combinations thereof. Process 600 is an example of act 516 of FIG. 5.

Initially, the directory server determines whether the requesting device has already been issued all of the lease(s) that are required for the requesting device to perform the operation (act 602). If all of the lease(s) have been issued, then the directory server withdraws the request from the request queue (act 604), and process 600 ends. Optionally, the directory server can send a request finished message to the requesting computing device (act 606) before process 600 ends. The request finished message indicates to the requesting computing device that processing of the request by the directory server has been completed. The request finished message indicates that the directory server has done all it believes is needed to satisfy the request; if the requesting computing device is unable to perform its operation then it sends another request to the directory server. This indication can be used by the client device to remove a request from its suppression set, as discussed in more detail below.

Returning to act 602, if the directory server determines that the requesting device has not already been issued all of the lease(s) that are required for the requesting device to perform the operation, then the directory server determines whether some of the required lease(s) can be issued to the requesting device (act 608). If some of the required lease(s) can be issued to the requesting device, then one or more of the required leases are issued to the requesting device (act 610), and process 600 ends. If some of the required lease(s) cannot be issued to the requesting device, then the conflicting lease(s) are recalled (act 612), and process 600 ends. The conflicting lease(s) are those lease(s) that are required to be issued to the requesting device in order for the requesting device to perform the operation, but that cannot be currently issued to the requesting device. The reasons why a lease cannot be currently issued to the requesting device can vary, such as because it is currently issued to another device, because it conflicts with another write lease that has been issued to another device (e.g., a read lease to a directory name in the file path of a child conflicts with a write lease for the child field), and so on.

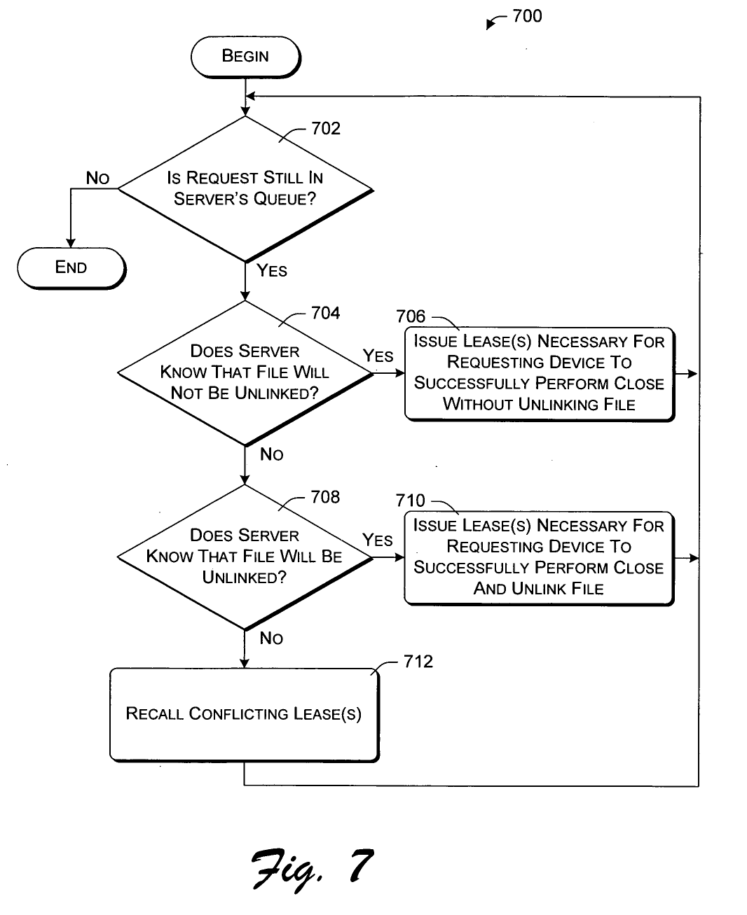

FIG. 7 illustrates an example process 700 for handling lease requests in a request queue for delete operations. Delete operations warrant special handling; process 700 handles this situation. Process 700 can be carried out, for example, by a directory server (e.g., computing device 104 of FIG. 1), and may be implemented in software, firmware, hardware, or combinations thereof.

In certain embodiments, such as those where the operating system is one of the family of Microsoft Windows® operating systems, deletion of files is accomplished by setting a delete-pending flag in the metadata of the file, and the last file to have a handle open on the file is responsible for deleting the file. This process of actually deleting the file is also referred to as unlinking the file.

Initially, the directory server checks whether the request is still in the request queue (act 702). If the request is no longer in the request queue, then process 700 ends for that request. Process 700 is repeated for the request until the request is no longer in the request queue.

If the request remains in the request queue, then the directory server determines whether the server knows that the file will not be unlinked (act 704). The directory server may not know whether the file will be unlinked because, for example, another computing device may have a write lease on the delete-pending field for the file, or another computing device may have a write lease on the handle open field. If the directory server knows that the file will not be unlinked, then the directory server issues one or more leases to the requesting device for the requesting device to successfully close the file without unlinking the file (act 706), and returns to the beginning of process 700 to repeat process 700. An example of the act 706 is discussed in more detail above as process 600 of FIG. 6.

Returning to act 704, if the directory server does not know that the file will not be unlinked, then the directory server determines whether the server knows that the file will be unlinked (act 708). If the directory server knows that the file will be unlinked, then the directory server issues one or more leases to the requesting device for the requesting device to successfully close and unlink the file (act 710), and returns to the beginning of process 700 to repeat process 700. An example of the act 710 is discussed in more detail above as process 600 of FIG. 6.

Returning to act 708, if the directory server does not know that the file will be unlinked, the directory server recalls the conflicting lease(s) (act 712), and returns to the beginning of process 700 to repeat process 700. The conflicting lease(s) are those lease(s) that are required to be issued to the requesting device in order for the requesting device to perform the operation, but that cannot be currently issued to the requesting device. As discussed above with respect to act 612 of FIG. 6, the reasons why a lease cannot be currently issued to the requesting device can vary.

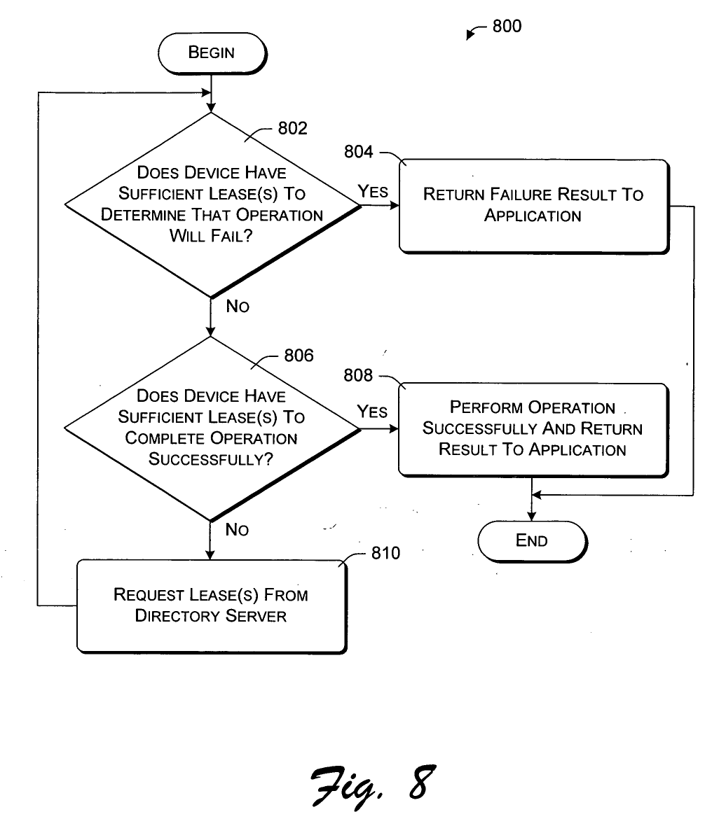

FIG. 8 illustrates an example process 800 for requesting leases. Process 800 can be carried out, for example, by a computing device (e.g., a computing device 102 of FIG. 1), and may be implemented in software, firmware, hardware, or combinations thereof. Process 800 is performed by a computing device when it receives a request from an application to perform an operation on a file.

Initially, the computing device determines whether it has sufficient lease(s) to determine that the requested operation will fail (act 802). If the computing device has sufficient lease(s) to determine that the operation will fail, then a failure result is returned to the application from which the request was received, and the requested file operation is not performed (act 804), and process 800 ends.

Returning to act 802, if the computing device does not have sufficient lease(s) to determine that the requested operation will fail, then the computing device determines whether it has sufficient lease(s) to complete the requested operation successfully (act 806). In certain embodiments, the computing device is programmed with or otherwise is readily able to identify which lease(s) it will need in order to perform the operation. Alternatively, the computing device may not know which lease(s) it will need, and relies on the directory server to inform it of which lease(s) it will need. The directory server can inform the computing device of which lease(s) it will need by, for example, sending a message to the computing device.

If the computing device has sufficient lease(s) to complete the operation successfully, then the computing device performs the requested operation and returns the result of the operation to the requesting application (act 808). If, however, the computing device does not have sufficient lease(s) to complete the operation successfully, then the computing device requests the needed lease(s) from the directory server (act 810). As discussed above, this request is typically a request for the necessary leases to perform the desired operation rather than a request for specific leases.

Thus, as can be seen in the processes of FIGS. 4-8, the lease management is performed in an efficient manner. Leases are obtained for different fields of the metadata associated with a file rather than for all of the metadata associated with a file and rather than for all of the metadata associated with multiple files concurrently. In this manner, only those leases needed to perform particular operations need be issued, thereby freeing the other leases for issuance to other computing devices.

As can be seen in process 800, the computing device repeatedly requests lease(s) from the directory server until it has sufficient lease(s) to determine that the operation will fail or to complete the operation successfully. Similarly, as can be seen in process 500 of FIG. 5, process 600 of FIG. 6, and process 700 of FIG. 7, the directory server repeatedly recalls lease(s) from the computing devices until the desired lease(s) are received from the computing devices. This repeating of lease requests and recalls is also referred to as pestering, and ensures that, even if the computing devices and directory servers are temporarily in states where they do not agree which has a particular lease (e.g., due to transmission delays), the appropriate lease request or recall will be issued and the computing devices and directory servers will eventually arrive in a configuration wherein the client computing devices hold the leases they need to make progress.

In certain embodiments, rather than repeatedly sending lease requests and/or lease recalls, suppression is employed to reduce the number of messages that are sent between devices. Each computing device maintains a suppression set that identifies requests or recalls that are to be suppressed. When a request or recall is to be sent, the computing device checks the suppression set and drops the request or recall if it is present in the suppression set.

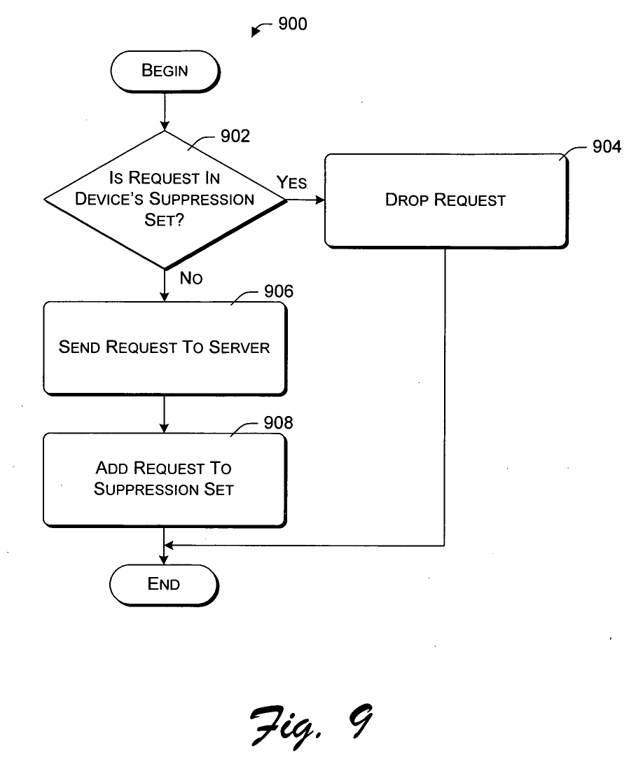

FIG. 9 illustrates an example process 900 for computing devices suppressing lease requests. Process 900 can be carried out, for example, by a computing device 102 of FIG. 1, and may be implemented in software, firmware, hardware, or combinations thereof. Process 900 is performed by a computing device when it is to send a lease request to a directory server.

Initially, a check is made as to whether the lease request is in the suppression set of the computing device (act 902). If the lease request is in the suppression set of the computing device, then the request is dropped (act 904), and process 900 ends. A dropped request is ignored by the computing device and is not sent to the directory server.

However, if the lease request is not in the suppression set of the computing device, then the lease request is sent to the directory server (act 906). The lease request is also added to the suppression set of the computing device (act 908), and process 900 ends.

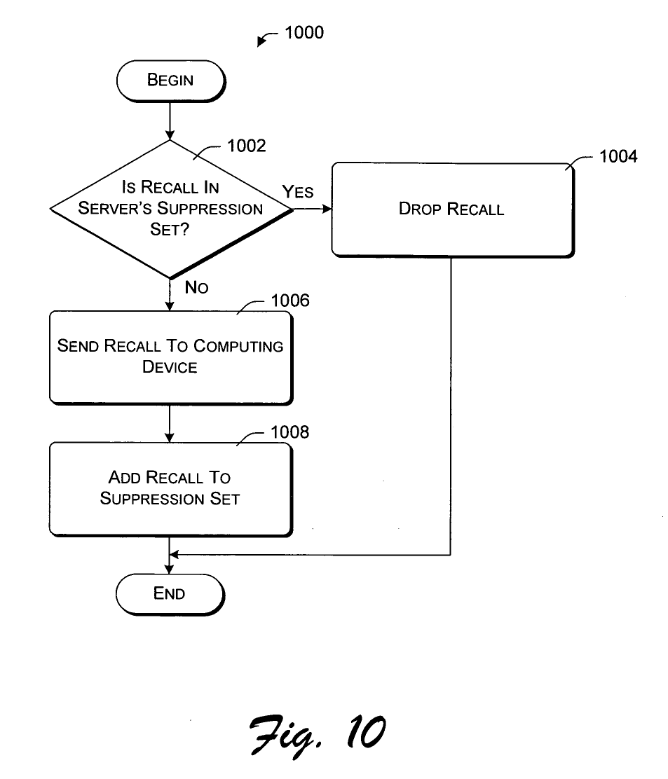

FIG. 10 illustrates an example process 1000 for directory servers suppressing lease requests. Process 1000 can be carried out, for example, by a computing device 104 of FIG. 1, and may be implemented in software, firmware, hardware, or combinations thereof. Process 1000 is performed by a directory server when it is to send a lease recall to a computing device.

Initially, a check is made as to whether the lease recall is in the suppression set of the directory server (act 1002). If the lease recall is in the suppression set of the directory server, then the lease recall is dropped (act 1004), and process 1000 ends. A dropped lease recall is ignored by the directory server and is not sent to the computing device.

However, if the lease recall is not in the suppression set of the directory server, then the lease recall is sent to the computing device (act 1006). The lease recall is also added to the suppression set of the directory server (act 1008), and process 1000 ends.

The processes discussed above describe generating lease requests and then suppressing those requests under certain circumstances, and generating lease recalls and then suppressing those recalls under certain circumstances. Alternatively, the lease request or recall processes can be combined with the suppression processes, so that the lease requests or recalls simply need not be generated under certain circumstances (rather than having them generated and subsequently dropped).

As discussed above, a computing device desiring to perform an operation on a file requests the lease(s) on the metadata of the file that are needed to perform the operation, and directory servers can recall leases. Computing devices can also voluntarily release leases (e.g., when they realize they no longer need the leases) by sending a release message to the directory server. When a computing device releases a lease, both the computing device and the directory server treat the lease as no longer being issued to the computing device.

Leases that are issued to a computing device typically have an expiration time. This expiration time can be an absolute value (e.g., Apr. 15, 2006 at 4:00 am), or can be relative (e.g., 10 hours after issuance). This can lead to situations where, as the lease expiration time approaches, the computing device that has the lease desires to keep the lease for a longer period of time and thus requests an extension of the lease. Alternatively, the directory server may notice that the lease expiration time is approaching and may re-issue the lease to the computing device without the computing device specifically requesting an extension. In response, the directory server re-issues the lease to the computing device, sending a lease issue message to the computing device with a lease that has a later expiration time.

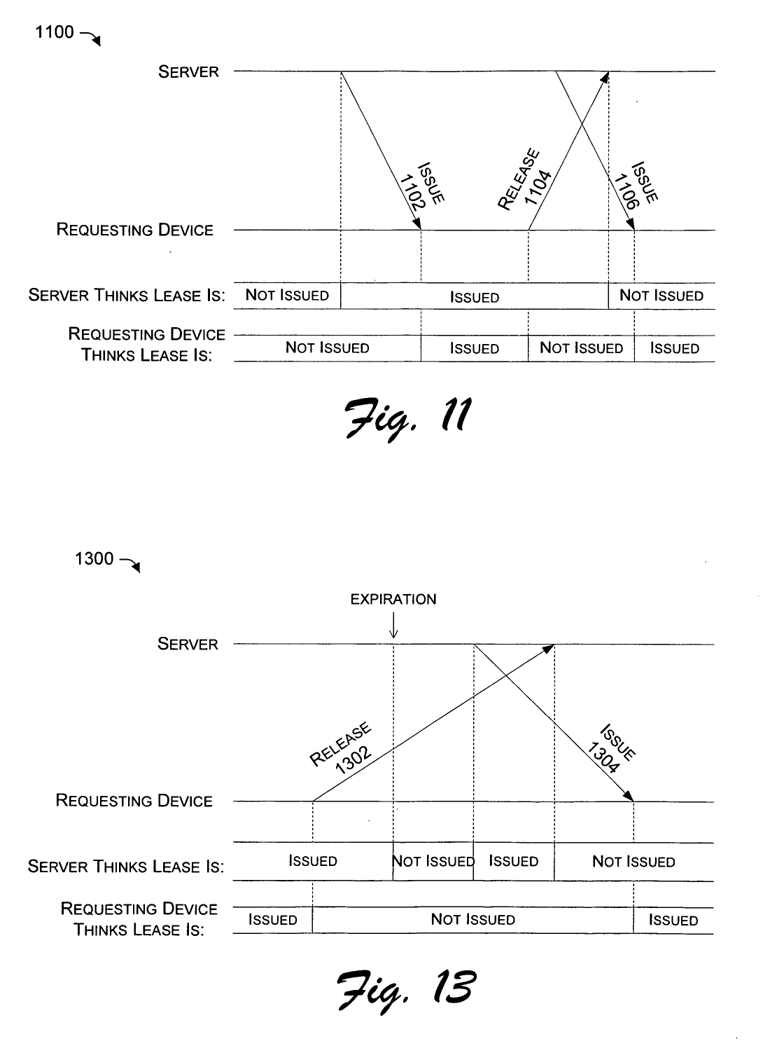

Extending leases, however, can lead to problems. FIG. 11 is a message flow diagram 1100 illustrating an example of such a problem. As illustrated in FIG. 11, an initial lease issue message 1102 is sent to a requesting computing device. Later, as the lease expiration time approaches, the computing device may send a release message 1104 to the directory server at approximately the same time as the directory server sends a lease issue message 1106 to the computing device extending the expiration time of the lease. When the directory server receives release message 1104, the directory server believes the lease with the extended expiration time (issued in message 1106, which was sent by the directory server prior to receipt of release message 1104) has been released. Therefore, the state of the lease maintained at the directory server is that the lease has not been issued to the computing device. However, when the computing device receives issue message 1106, the computing device believes that it has received the lease with the extended expiration time (issued in message 1106, which was received by the computing device after sending release message 1104). Therefore, the state of the lease maintained at the computing device is that the lease has been issued to the computing device. Therefore, there is an unsafe inconsistency between the directory server and the computing device regarding whether the lease has been issued.

In order to prevent such inconsistencies from occurring, an exclusive enable policy is enforced. In accordance with the exclusive enable policy, if a server is enabled to issue a lease to a particular computing device then the computing device is not enabled to release the lease. Similarly, if a computing device is enabled to release the lease, then the directory server is not enabled to issue the lease to that computing device. The exclusive enable policy employs an additional message type referred to as a lease extension message. When a lease has been issued to a computing device, the directory server is enabled to extend that lease by sending a lease extension message to the computing device. Computing devices interpret any lease extension messages they receive with respect to the current issued lease—if the computing does not have any current lease (e.g., because it released the lease), then the computing device ignores any lease extension it receives.

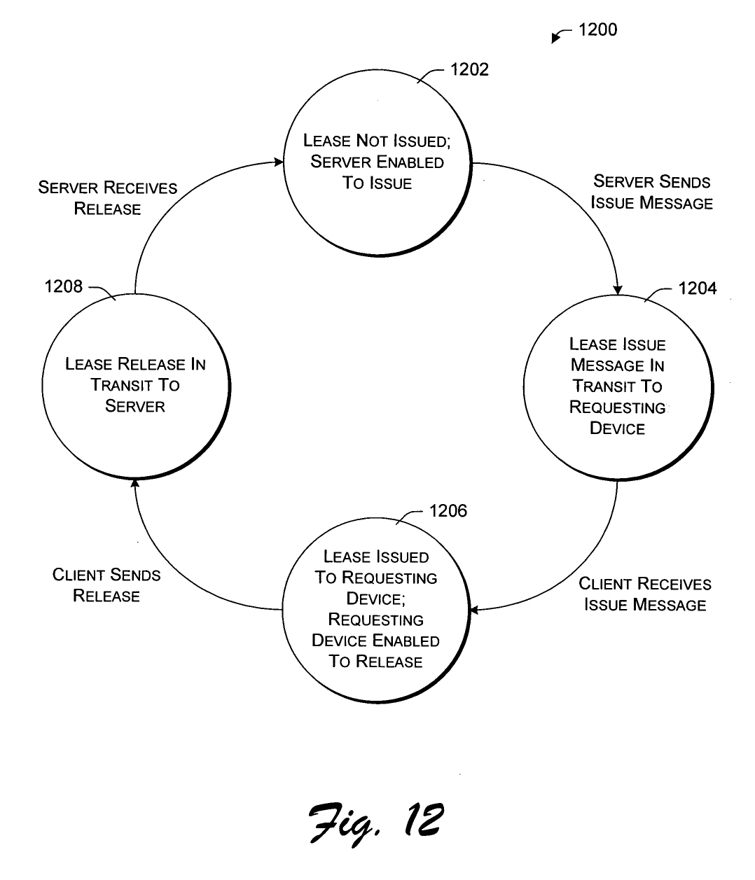

FIG. 12 is a state diagram 1200 illustrating example states of a system employing the exclusive enable policy. For purposes of this diagram, the states are defined with respect to a particular lease and a particular computing device. At state 1202, the lease has not been issued, so the directory server is enabled to issue the lease to the computing device. In response to a request from the computing device, the directory server sends a lease issue message to the requesting device, and the state transitions to state 1204 where the lease issue message is in transit to the requesting device. The requesting device receives the issued lease, and the state transitions to state 1206 where the lease is issued to the requesting device so the requesting device is enabled to release the lease. When the requesting device releases the lease, the client sends a release message to the directory server, and the state transitions to state 1208 where the lease release is in transit to the server directory. The server directory receives the lease release, and the state transitions to state 1202, where the lease has not been issued and the directory server is enabled to issue the lease.

The directory server is enabled to send a lease extension message in states 1204, 1206, and 1208. The directory server is typically not enabled to send a lease extension message in state 1202 because the directory server would send a lease issue message rather than a lease extension message.

Additionally, as discussed above, there are two mechanisms that can cause an issued lease to become no longer issued: expiration of the lease and a lease release message. An additional problem can arise with respect to these two different mechanisms. FIG. 13 is a message flow diagram 1300 illustrating an example of such a problem. As illustrated in FIG. 13, a computing device sends a lease release message 1302 to the directory server prior to expiration of the lease, but message 1302 does not arrive at the directory server until after the lease expires. After the lease expires, but before message 1302 is received, the directory server sends a lease issue message 1304 to the computing device. The computing device receives issue message 1304 after it sent release message 1302, so the state of the lease maintained at the computing device is that the lease has been issued to the computing device. The directory server, however, receives release message 1302 after it sent issue message 1304, so the state of the lease maintained at the server directory is that the lease has not been issued to the computing device. Therefore, there is an inconsistency between the directory server and the computing device regarding whether the lease has been issued.

In order to prevent such inconsistencies from occurring, lease release messages from the computing device include the expiration time of the lease being released. The lease expiration time is already maintained by the computing device, so no additional information to identify different leases need be maintained by the computing device in order to prevent such inconsistencies from occurring. For example, although nonces may be used to identify different leases and prevent such inconsistencies from occurring, the techniques described herein do not require nonces and thus do not require the additional overhead of keeping track of nonces.

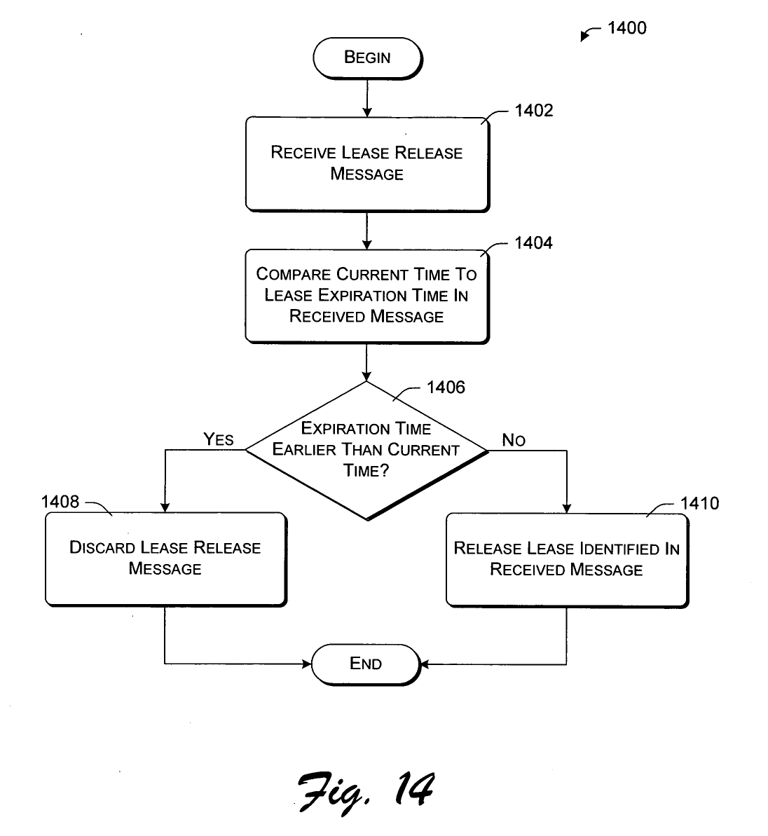

FIG. 14 illustrates an example process 1400 for directory servers processing lease release messages. Process 1400 can be carried out, for example, by a computing device 104 of FIG. 1, and may be implemented in software, firmware, hardware, or combinations thereof.

Initially, the directory server receives a lease release message (act 1402). The directory server compares the current time at the directory server to the lease expiration time included in the lease release message (act 1404). The directory server checks whether the expiration time in the lease release message is earlier than the current time at the directory server (act 1406), and if the expiration time in the lease release message is earlier than the current time at the directory server, then the lease release message is discarded (act 1408). If, however, the expiration time in the lease release message is not earlier than the current time at the directory server, then the lease identified in the lease release message is released (act 1410), so it is no longer issued to the computing device from which the lease release message was received.

Thus, referring to FIG. 13, lease release message 1302 would be received at the directory server after the expiration time of the lease, so the expiration time in the lease release message would be earlier than the current time at the directory server and lease release message 1302 would be discarded by the directory server. Therefore, the state of the lease maintained at the server directory would remain that the lease has been issued to the computing device.

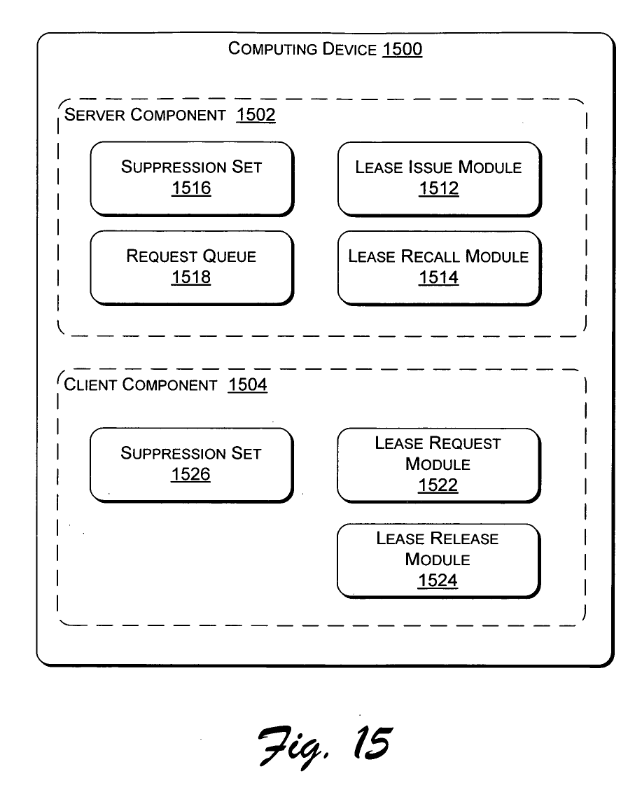

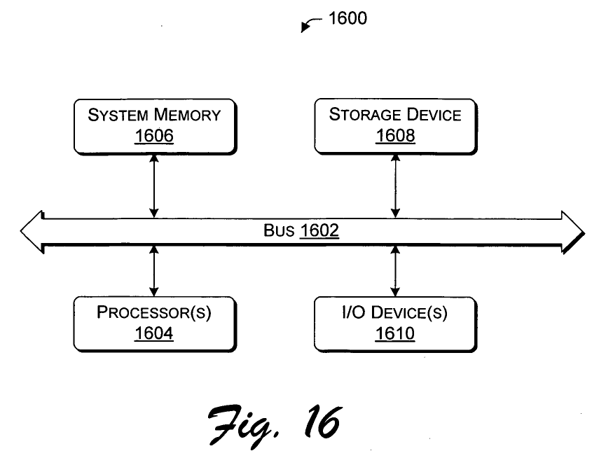

FIG. 15 illustrates logical components of an example computing device 1500 that is representative of any one of the devices 102 or 104 of FIG. 1, or devices 202-206 of FIG. 2. Computing device 1500 includes a server component 1502 and a client component 1504. Although device 1500 is illustrated as including both server component 1502 and client component 1504, alternatively a computing device may include only one of server component 1502 or client component 1504. Server component 1502 and client component 1504 can exist in different parts of a computing device. For example, software instructions for implementing components 1502 and 1504 may be stored on a mass storage device until computing device 1500 is powered on, at which point the software instructions are copied into random access memory (RAM). Computing device 1500 also typically includes additional components (e.g., a processor, RAM, read only memory (ROM), a mass storage device(s), etc.), however these additional components have not been shown in FIG. 15 so as not to clutter the drawings. Alternatively, one or more components 1502 and 1504, or portions thereof, may be implemented in hardware. A more general description of a computer architecture with various hardware and software components is described below with reference to FIG. 16.

Server component 1502 handles requests when device 1500 is responding to a request involving a file stored (or to be stored) in a storage device of computing device 1500, while client component 1504 handles the issuance of requests by device 1500 for files stored (or to be stored) in the file system. Client component 1504 and server component 1502 operate independently of one another. Thus, situations can arise where the serverless distributed file system 250 causes files being stored by client component 1504 to be stored in a mass storage device of computing device 1500 by server component 1502.

Server component 1502 includes a lease issue module 1512, a lease recall module 1514, a suppression set 1516, and a request queue 1518. It should be noted that in certain embodiments not all computing devices in a distributed file system need include a lease issue module 1512, a lease recall module 1514, a suppression set 1516, and a request queue 1518. Rather, only those computing devices that may be configured to operate as, or that are actually operating as, a directory server may include these components. Additional components may also be included in server component 1502, such as components for encrypting files, storing files, determining locations of files, and so forth. However, these components have not been illustrated in FIG. 15 in order to avoid cluttering the drawings.

Lease issue module 1512 receives requests for leases from computing devices and issues the appropriate lease(s) to the requesting devices. Lease recall module 1514 recalls leases as necessary to respond to requests for leases from computing devices. Suppression set 1516 is a record of recall messages that have been sent to computing devices. Request queue 1518 is a queue of requests received from one or more requesting devices.

Client component 1504 includes a lease request module 1522, a lease release module 1524, and a suppression set 1526. Additional components may also be included in client component 1504, such as components for creating files and directories, storing files and directories, retrieving files and directories, reading files and directories, writing files and directories, modifying files and directories, verifying files and directories, and so forth. However, these components have not been illustrated in FIG. 15 in order to avoid cluttering the drawings.

Lease request module 1522 issues requests to the directory server for leases to perform operations. Lease release module 1524 issues lease release messages to the directory server to release leases that have been issued to computing device 1500. Suppression set 1526 is a record of lease request messages that have been sent to the directory server.

FIG. 16 illustrates an example of a general computing device 1600 that can be used to implement the file metadata lease management discussed herein. Computing device 1600 can be any one of the devices 102 or 104 of FIG. 1, and/or any one of the devices 202-208 of FIG. 2. Computing device 1600 is only one example of a computing device and is not intended to suggest any limitation as to the scope of use or functionality of the computing device and network architectures. Neither should computing device 1600 be interpreted as having any requirement regarding the inclusion (or exclusion) of any components or the coupling or combination of components illustrated in the example computing device 1600.

Computing device 1600 is a general-purpose computing device that can include, but is not limited to, one or more processors or processing units 1604, a system memory 1606, and a bus 1602 that couples various system components including the processor 1604 to the system memory 1606.

Bus 1602 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

System memory 1606 includes computer readable media in the form of volatile memory, such as random access memory (RAM), and/or non-volatile memory, such as read only memory (ROM) 1612.

Computing device 1600 may also include other removable/non-removable, volatile/non-volatile computer storage device 1608. By way of example, storage device 1608 may be one or more of a hard disk drive for reading from and writing to a non-removable, non-volatile magnetic media, a magnetic disk drive for reading from and writing to a removable, non-volatile magnetic disk (e.g., a “floppy disk”), an optical disk drive for reading from and/or writing to a removable, non-volatile optical disk such as a CD, DVD, or other optical media, a flash memory device, and so forth. These storage device(s) and their associated computer-readable media provide storage of computer readable instructions, data structures, program modules, and/or other data for computing device 1600.

User commands and other information can be entered into computing device 1600 via one or more input/output (I/O) devices 1610, such as a keyboard, a pointing device (e.g., a “mouse”), a microphone, a joystick, a game pad, a satellite dish, a serial port, a universal serial bus (USB), a IEEE 1394 bus, a scanner, a network interface or adapter, a modem, and so forth. Information and data can also be output by computing device 1600 via one or more I/O devices 1610, such as a monitor, a printer, a network interface or adapter, a modem, a speaker, and so forth.

An implementation of the file metadata lease management described herein may be described in the general context of computer-executable instructions, such as program modules, executed by one or more computing devices. Generally, program modules include routines, programs, objects, components, data structures, etc. that perform particular tasks or implement particular abstract data types. Typically, the functionality of the program modules may be combined or distributed as desired in various embodiments.

An implementation of the file metadata lease management may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Alternatively, all or portions of these modules and techniques may be implemented in hardware or a combination of hardware, software, and/or firmware. For example, one or more application specific integrated circuits (ASICs) or programmable logic devices (PLDs) could be designed or programmed to implement one or more portions of the framework.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer readable media having stored thereon a plurality of instructions that, when executed by one or more processors, causes the one or more processors to:
receive, from a device in a computer network, a request for one or more leases to permit the device to perform an operation on a file, metadata of the file being subdivided into a plurality of fields and each of the plurality of fields having a separate associated lease, each of the one or more leases being associated with a different one of the plurality of fields of the file;
determine whether the operation can succeed;
issue, to the device, the one or more leases to perform the operation if it is determined that the operation can succeed; and
issue, to the device, one or more leases that reveal failure to the device if it is determined that the operation cannot succeed.

2. One or more computer readable media as recited in claim 1, wherein the plurality of fields include a checksum field, a delete-pending field, a parent field, at least one child field, a handle open field, and at least one handle open for a particular mode field.

3. One or more computer readable media as recited in claim 1, wherein the request identifies the operation and wherein the plurality of instructions further cause the one or more processors to identify the one or more leases needed by the device to perform the operation.

4. One or more computer readable media as recited in claim 1, wherein the plurality of instructions further cause the one or more processors to repeatedly recall one of the one or more leases issued to a second device in the computer network until the one lease is released by the second device.

5. One or more computer readable media as recited in claim 4, wherein the plurality of instructions further cause the one or more processors to:
check whether a recall message has already been sent to the second device; and
not send an additional recall message to the second device to recall the one lease from the second device if a recall message to recall the one lease from the second device has already been sent to the second device.

6. One or more computer readable media as recited in claim 1, wherein the one or more processors are included in a directory server, and wherein the plurality of instructions further cause the one or more processors to enforce an exclusive enable policy in which the directory server is not enabled to issue one of the one or more leases to the device if the device is enabled to release the one lease.

7. One or more computer readable media as recited in claim 1, wherein the one or more processors are included in a directory server, and wherein the plurality of instructions further cause the one or more processors to:
receive a lease release message from the device;
check whether the expiration time in the lease release message is earlier than a current time at the directory server; and
discard the lease release message if the expiration time in the lease release message is earlier than the current time at the directory server.

8. A method, implemented at least in part by a first computing device, the method comprising:
sending, to a second computing device in a computer network, a request for one or more leases that are needed by the first computing device in order to perform an operation on a file, each of the one or more leases being associated with a different metadata field of the file;
receiving, from the second computing device, at least one of the one or more leases; and
using the at least one lease to determine whether the first computing device can perform the operation on the file.

9. A method as recited in claim 8, wherein the different metadata fields of the file include a checksum field, a delete-pending field, a parent field, at least one child field, a handle open field, and at least one handle open for a particular mode field.

10. A method as recited in claim 8, wherein the request identifies the operation and wherein the second computing device identifies the one or more leases needed by the first computing device to perform the operation.

11. A method as recited in claim 8, further comprising repeatedly sending the request to the second computing device until the at least one of the one or more leases is received from the second computing device.

12. A method as recited in claim 11, further comprising:
checking whether a request message to request the one or more leases has already been sent to the second computing device; and
not sending another request message to the second device to request the one or more leases if a request message to request the one or more leases has already been sent to the second computing device.

13. A method as recited in claim 8, further comprising enforcing an exclusive enable policy in which the first computing device is not enabled to release one lease of the at least one lease if the second computing device is enabled to issue the one lease.

14. A method as recited in claim 8, further comprising:
generating a lease release message to release one lease of the at least one lease;
including, in the lease release message, an expiration time of the one lease; and
sending the lease release message to the second computing device.

15. A system comprising:
a client component, the client component including a lease request module to:
send a request for one or more leases that are needed by the client component in order to perform an operation on a file, each of the one or more leases being associated with a different metadata field of the file;
receive at least one of the one or more leases; and
use the at least one lease to determine whether the client component can perform the operation on the file; and
a server component, the server component including a lease issue module to:
receive the request for one or more leases;
determine whether the operation can succeed;
issue, to the client component, the one or more leases to perform the operation if it is determined that the operation can succeed; and
issue, to the client component, one or more leases that reveal failure to the client component if it is determined that the operation cannot succeed.

16. A system as recited in claim 15, wherein the request identifies the operation and wherein the lease issue module is further to identify the one or more leases needed by the client component to perform the operation.

17. A system as recited in claim 15, wherein the server component further comprises a lease recall module to repeatedly recall the one of the one or more leases issued to a second system until the one lease is released by the second system.

18. A system as recited in claim 17, wherein the lease recall module is further to:
check whether a recall message has already been sent to the second system; and
not send an additional recall message to the second system to recall the one lease from the second system if a recall message to recall the one lease from the second system has already been sent to the second system.

19. A system as recited in claim 15, wherein the lease issue module is not enabled to issue one of the one or more leases to the client component if the client component is enabled to release the one lease.

20. A system as recited in claim 15, wherein lease issue module is further to:
receive a lease release message from the client component;
check whether the expiration time in the lease release message is earlier than a current time at the server component; and
discard the lease release message if the expiration time in the lease release message is earlier than the current time at the server component.
